(19) United States
(12) Patent Application Publication
(10) Pub. No.: US 2019/0088237 A1
(43) Pub. Date: Mar. 21, 2019

(54) System and Method of Generating Signals from Images

(71) Applicant: Rocco Anthony DePietro, III, Novi, MI (US)

(72) Inventor: Rocco Anthony DePietro, III, Novi, MI (US)

(21) Appl. No.: 16/125,754

(22) Filed: Sep. 9, 2018

Related U.S. Application Data
(60) Provisional application No. 62/556,438, filed on Sep. 10, 2017.

(51) Int. Cl. G10H 1/00; G09G 5/10; G06F 3/0484; G06F 3/0488

(52) U.S. Cl. CPC G10H 1/00; G09G 5/10; G06F 3/04842; G06F 3/04883; G06F 3/04845

(57) ABSTRACT

Devices and methods for improving the field of signal generation are provided by transforming computer images into signals. In some embodiments the invention relates to computer music synthesis applications. Other applications include but are not limited to, speech, text, numerical, digital or analogue signals, and other signals that can be generated from images. Some embodiments include an electronic display or displays, and one or more input devices, processors and output devices.

### BACKGROUND OF THE INVENTION

The present invention is in the technical field of computer signal processing. More specifically, the invention relates to signal synthesis. In some embodiments the invention relates to computer music synthesis applications. Other embodiments include other types of signal synthesis. These include but are not limited to, speech, text, numerical, digital or analogue signals, and other signals that can be generated from images. The concepts disclosed herein have not necessarily been previously described, conceived, or implemented in prior art and thus, unless otherwise noted, should not necessarily be considered as such.

A variety of signal processing applications are available. Many signal processing applications in the field of computer music use a first stored sound or sounds as the input and edit the image graphically into a second, modified sound. A distinction is made here between two types of computer music applications; those which are note-based which employ notes played on emulated musical instruments, and those which are graphical-based, which facilitate editing of computer images not directly related to musical notes or instruments. In the case of note-based or instrument-based editing tools, the user should possess some knowledge of musical notes, scales or musical instruments. In the case of non-note-based computer music applications, in some embodiments the user modifies an image representation of a sound that is further processed and output as a new sound, without knowledge of musical notes or instruments. In this case often the original image is created from a first sound or sounds, and graphically modified by the user into a second modified sound or sounds. Many of the aforementioned computer music applications are complex and unintuitive. They often employ advanced mathematics including algorithms and transforms not fully understood by many users. Furthermore, there is often no intuitive or obvious relationship between the input image and the output sound of these applications. Often the audio output sounds very unnatural and electro-mechanical. One improvement of the disclosed invention is to make graphical audio synthesis accessible to those who do not possess a knowledge of musical instruments, notes, or scales by providing a direct and intuitive relationship between an input image and its corresponding output sound. Another improvement provided is to eliminate the complexity of other graphical synthesizers that employ complex algorithms and output unnatural sounds. One solution that some embodiments provide is more intuitive editing of an image and subsequent output a more natural sound.

### SUMMARY OF THE INVENTION

Some embodiments provide a system and method for generating sounds from computer images. Other embodiments provide a system and method for generating other digital or analogue signals from images that are not necessarily related to sounds, including but not limited to text, speech, numerical data or other signals that can be generated from images. The invention provides images consisting of pixels drawn directly in a drawing application, converted into a signal that can be played as a sound. Other embodiments provide stored images that can be displayed, edited, and output as sounds. Some embodiments provide stored sounds that are converted into images, then edited and output as audio. Furthermore, some embodiments provide an input image or stored sound that is converted to or displayed as an image and edited in a variety of ways, then output as a second sound or stored as audio data or other forms of data. The computer images used by the application can be of any origin, color, intensity, dimensions, size or shape. Similarly, input signals used to create images can be of any origin. In some embodiments the image or images can be edited in a plurality of ways, including reshaped column or row-wise, resized, rotated, moved, stretched or cropped, filtered or otherwise modified by any available image editing operations. An image can also be stored and applied as a brush in a drawing application. For the purpose of this disclosure, sounds, computer music and audio are synonymous. Images, computer images, pictures and pixels are also used interchangeably and intended to mean a graphic that can be displayed by a computer. A computer music editing application is related to program residing on a computer that generate signals from images, generally considered to be any computer program that provides graphical editing and/or graphical synthesis of an input sound or input image and then outputs a modified sound or sounds.

### BRIEF DESCRIPTION OF THE DRAWINGS

Novel features of the invention are set forth in the claims section following illustrations and detailed descriptions of some embodiments. For conceptual and demonstrative purposes, illustrations are provided in the following figures. For a more comprehensive description, a detailed description is provided referencing the figures in-depth.

FIG. 1 Illustrates an exemplary electronic system with which some embodiments of the invention are implemented.

FIG. 2 Is a flowchart representation conceptually illustrating some embodiments of the method of signal generation from images pertaining to the system in FIG. 1

FIG. 3 Is a conceptual illustration of digitizing an analogue signal;

FIG. 4 Illustrates one possible method of transforming digital images into signals as used in the system of FIG. 1 and the method of FIG. 2;

FIG. 5 Describes in further detail the method of transforming images into signals as shown in FIG. 4;

FIG. 6 Illustrates embodiments of exemplary devices of the system of FIG. 1 and the method of FIG. 2;

FIG. 7 Illustrates an exemplary user interface used in the exemplary devices in FIG. 6

FIG. 8 Expands upon the exemplary user interface illustrated in FIG. 7;

FIG. 9 Illustrates artistic effects being applied in an exemplary user interface;

FIG. 10 Illustrates a custom selection user interface feature in some embodiments of the user interfaces in FIG. 7 thru 9 for the exemplary devices of FIG. 6;

### DETAILED DESCRIPTION OF THE INVENTION

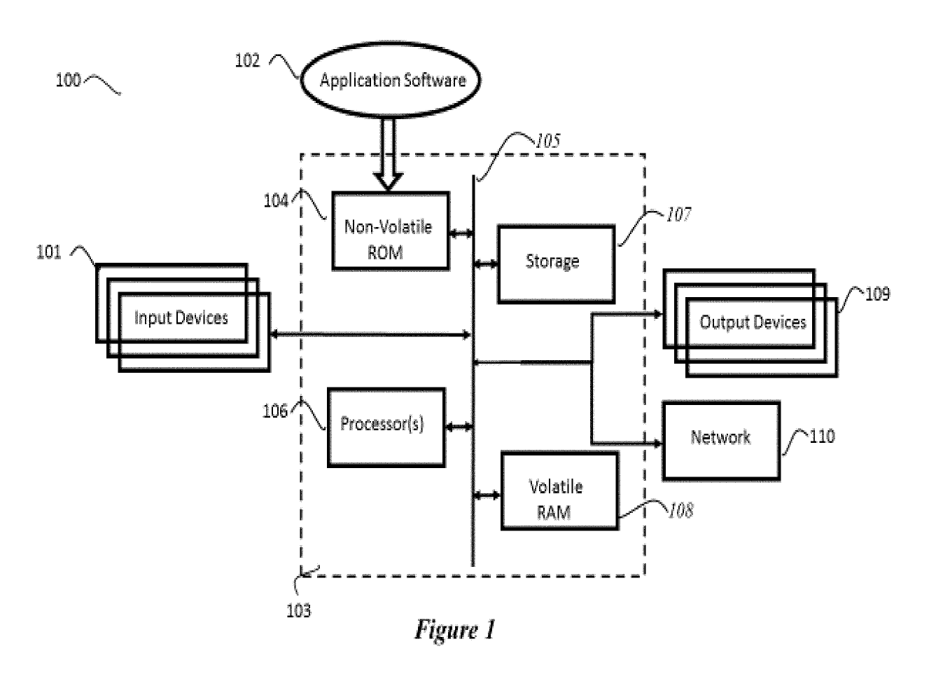

Referring now to the invention in more detail, in FIG. 1 there is shown an exemplary electronic apparatus (also known as electronic system) 100 with which some embodiments of the invention are implemented. In some embodiments the electronic apparatus/system 100 may be a desktop computer, a laptop computer, a tablet computer, a smartphone, a media player, a television, a gaming system, or any other electronic device. Such portable or non-portable electronic systems typically include one or more input devices 101 which may in some embodiments can include a mouse, keyboard, touch screen display, pen tablet, and other input devices such as a joystick, midi player, media player, usb device, camera, electronic instruments, microphones, and any other input devices that can interface with the electronic system of 100. Application software 102 is the set of instructions, also known as a computer program, or application, that executes the invention on electronic system 100 and in some embodiments resides in the non-volatile memory or ROM, 104 which is part of the Hardware Layer 103. Some exemplary electronic systems 100 contain a Hardware Layer 103 that may include one or more Processor(s) 106, Storage media 107, Volatile memory (or RAM) 108 and output device(s) 109. The output device(s) 109 may include, without limitation, speakers, displays of any kind which can serve as both Input and Output devices, removable storage media, or any other output device that can be connected to an electronic system. The subsystem components of system 100 listed above are typically interconnected by a BUS 105 and are sometimes optionally connected to a Network 110.

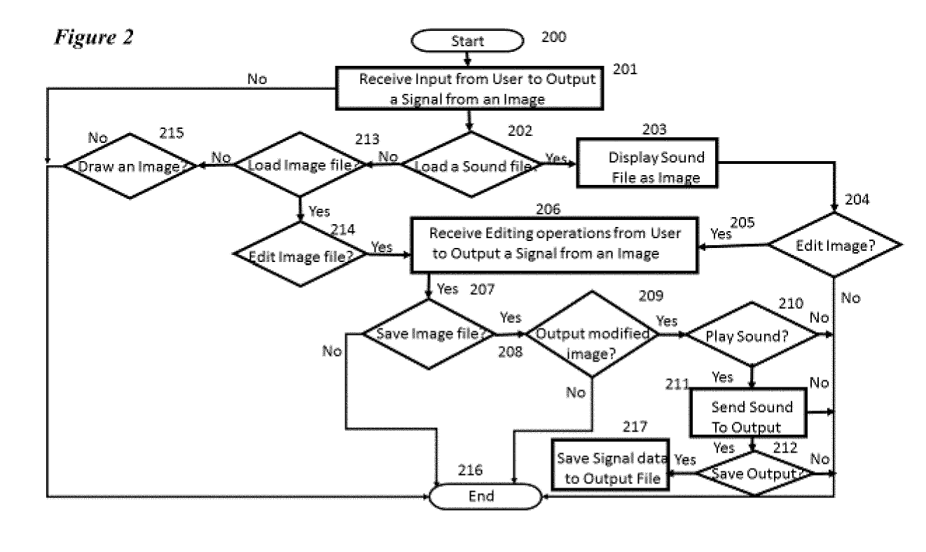

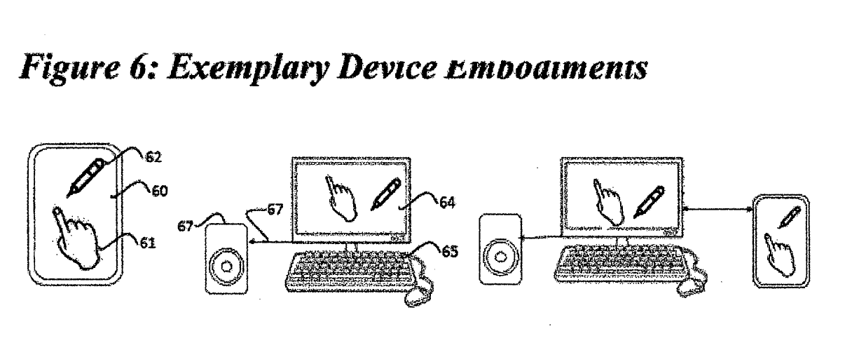

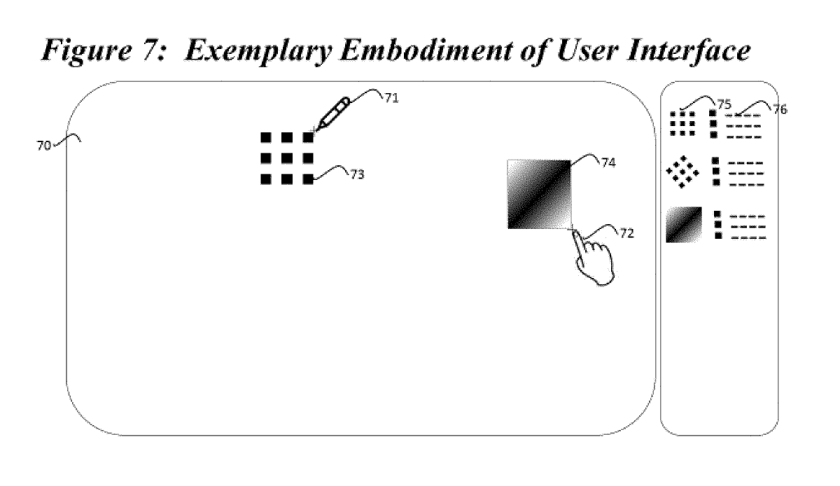

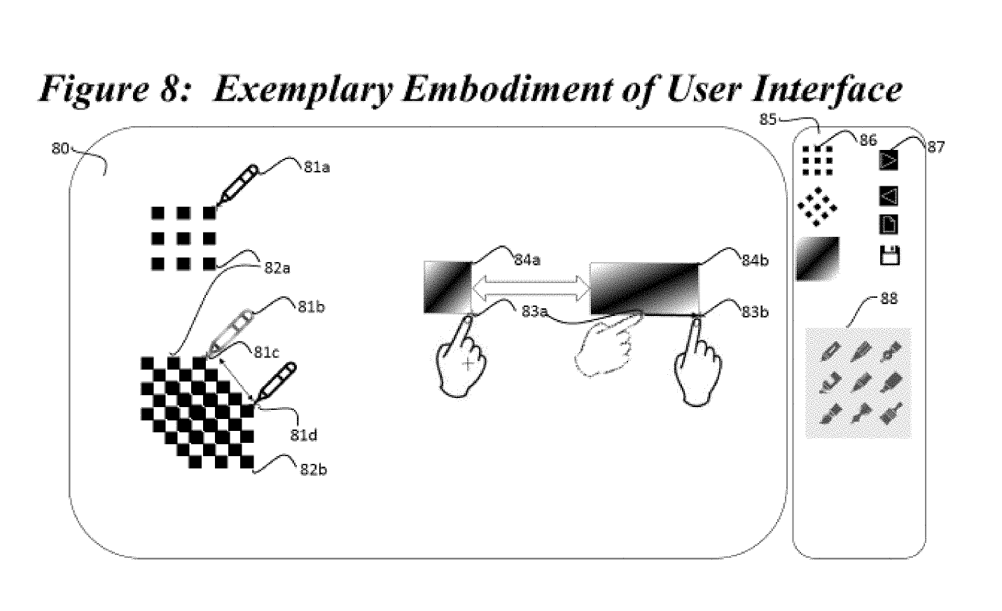

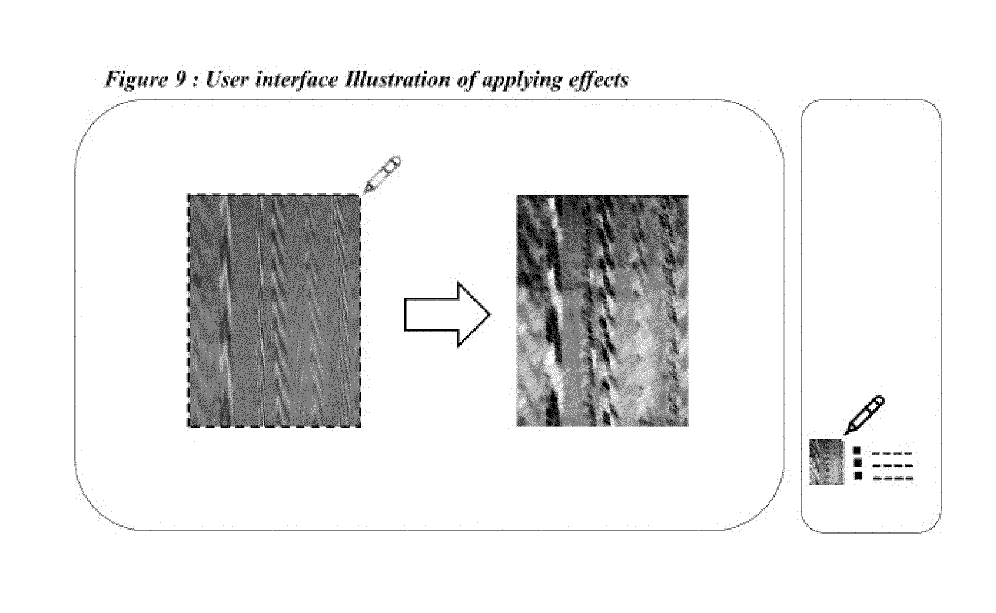

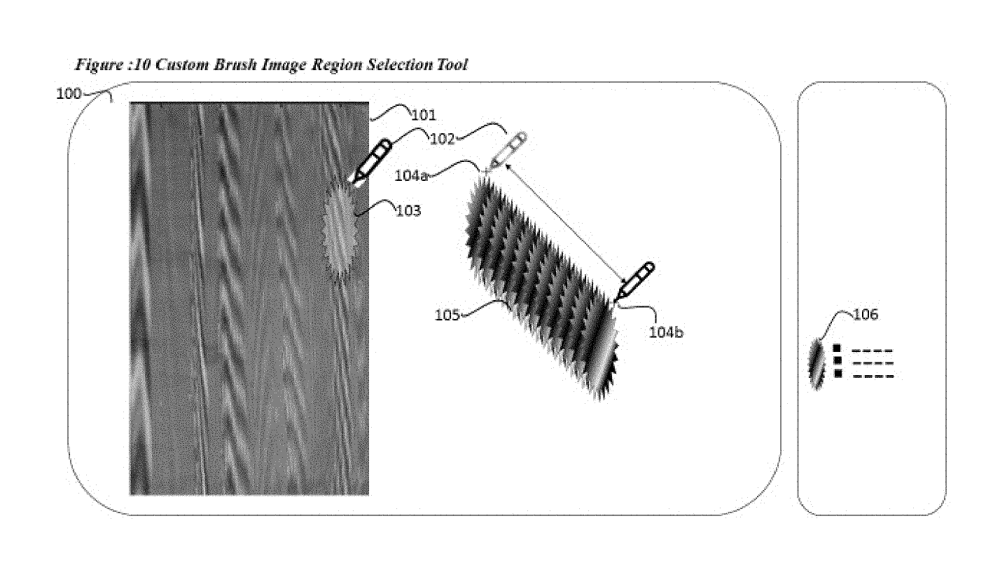

FIG. 2 is a conceptual illustration of a process flow of some embodiments of an electronic system as illustrated in FIG. 1 that generates a signal from an image. Input is received from the user to start 200 the process. The process proceeds to 201 where it is determined whether a signal is to be output from an image. If Yes, the user is prompted to load a sound file and display as an image 202. If not, the process terminates at End 216. Proceeding from 202, either a sound file is loaded and displayed at 203, or if not, the user is prompted to load an image file at 213. Proceeding from 203, the sound file is displayed as an image and the user is prompted to edit the image at 204. If Yes 205, the image is edited at 206 as shown in some embodiments in FIG. 7, FIG. 8, FIG. 9, and FIG. 10. The process continues to 207 where the image can be saved to a file at 208. At 209, the modified image can be output. At 210, the modified image can be played as a sound in some embodiments, for example sound can be output is to speakers 211 as shown in FIGS. 6A, 6B, 6C. Other outputs are possible in other embodiments. The process is continued at 212 where the modified output signal or sound can be saved in process 217. It is further noted that the above process is one conceptual illustration of a process flow of some embodiments. The process flow and enumerations may be different in other embodiments wherein the enumerated steps are possible in other combinations and are not necessarily sequential. Some embodiments would allow the Start 200 to occur preceding any of the enumerations of the process and likewise the End 216 would be allowed to follow any of the enumerations. Some embodiments would allow the enumerations to be rearranged in a different order than shown in FIG. 2 without changing the essence of the process flow.

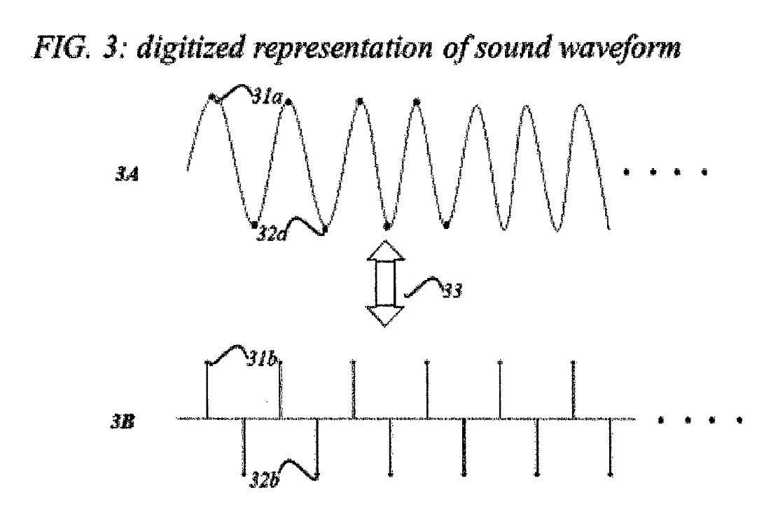

FIG. 3 Is a conceptual illustration of how a signal is digitized. In 3A an analogue signal is shown. An analogue signal could be a sound wave or any other analogue signal. In 3B a digitized signal is shown. The digitized signal in 3B is a discretized representation of the analogue signal in 3A. For example, the locations in the signal corresponding to one peak 31a and one valley 32a in analogue signal 3A are shown as discrete samples in the corresponding sample points peak 31b and analogous valley 32b in FIG. 3B after being digitized by Transform 33. To those skilled in the art of signal processing, is understood that the signal in 3A can be transformed into the signal in 3B and vice-versa via the transform process 33 of analogue to digital conversion and its reverse, also denoted by 33, digital to analogue conversion.

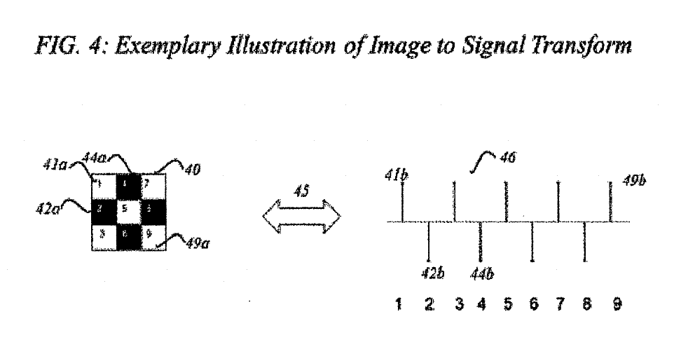

FIG. 4 is a conceptual illustration of how some embodiments of the exemplary electronic system in FIG. 1 generates a signal from an image. Building upon the concept of digitized signals as outlined in FIG. 3, FIG. 4 shows conceptually how an image is transformed into a signal in some embodiments. FIG. 4A shows an example of an image or portion thereof consisting of a pixel region 40, and discrete pixels 41a, 42a, 44a, and 49a (inclusively numbered 1 thru 9) of said image. In some embodiments the image or images are displayed as one or more pixels, and the pixels comprising the image(s) are arranged in rows and columns. In some embodiments of pixel region 40 the rows begin at top left corner 40a and the first row contains elements 1,4,7, for example. Furthermore, the columns of some embodiments also begin at the top left corner element 40a, the first column consisting of elements 1,2,3. In some embodiments the rows are ordered from the top down, and the columns from left to right, but other arrangements and orders are possible. In some embodiments pixel region 40 consists of one or more pixels, rows, and columns. Furthermore, the pixels in some embodiments can be of any one or more color, tone, or intensity value. Proceeding with the pixel region 40, in some embodiments consisting of one or more pixels arranged in one or more rows and columns, the signal is undergoes transform process 45. In some embodiments the transform 45 assigns a one-to-one relationship between the pixel region 40 of an image and the output signal as shown in 4B. The output signal 46 from the transform 45 of the pixel region 40 is shown in FIG. 4B in some embodiments. In the present illustration as an example a white pixel is given a value of “1” and a black pixel is given the value of “−1” via the transform 45, but other values are possible. Reading from top to bottom and left to right in pixel region 40 and via the transform 45 the transformed values are depicted in the output signal 46. For instance, in some embodiments of transform 45, the pixel corresponding to the first element, 41a, is transformed via 45 to a value of “1” in the first position of output signal 46 as 41b, but other relationships are possible. Following in the order depicted in the example in FIG. 4A, the second element in pixel region 40, namely 42a, is transformed by 45 into the second position in the output signal 45, namely 42b, with a value of “−1” and so on and so forth. Following the same transform process outlined above, the element 44a is transformed into element 44b, and 49a is transformed into 49b.

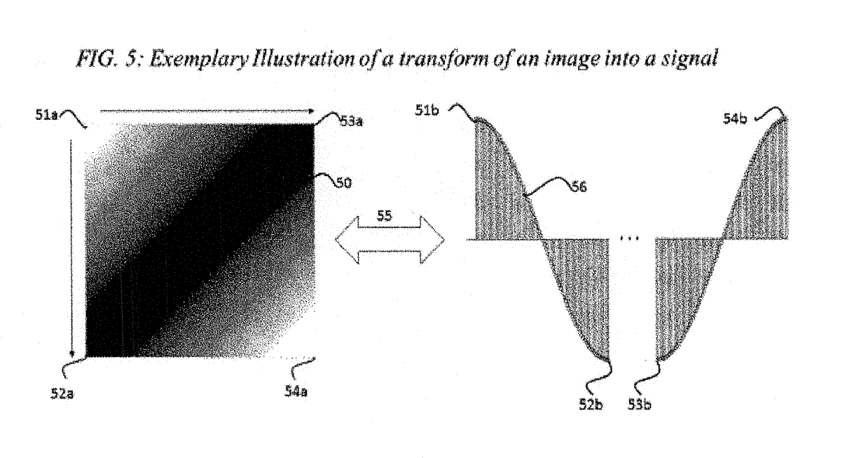

FIG. 5 expands upon the concepts illustrated in FIG. 4, showing how some embodiments transform an image or images containing an arbitrary number of pixels into a signal. FIG. 5A consists of pixel region 50, and an arbitrary number of pixels of arbitrary color and intensity, four of which are enumerated as 51a,52a,53a, and 54a for illustrative purposes. In some embodiments, transform 55 assigns the pixel color and intensity values in FIG. 5A to the output signal 56 shown in 5B. Following the process outlined above in FIGS. 4A and 4B, the pixels at positions 51a, 52a, 53a, and 53b in pixel region 50 are transformed into the values of the of output signal 56 correspondingly to output values of 51b, 52b, 53b, and 54b respectively.

FIG. 6 shows illustrations of some embodiments of electronic systems that generate output signals from images. FIG. 6a shows a tablet 60 or similar device with optional touchscreen 61 and optional pen input 62. Optionally the example in 6a may be connected to or contain output devices including without limitation, speakers 67, other displays, a network, or other output devices. FIG. 6b shows a desktop computer 65 or other computing device with optional touchscreen 64 and optional pen input. Optionally the example in 6b may be connected to or contain output devices including without limitation, speakers 67, other displays, a network, or other output devices. FIG. 6c shows a desktop computer or other computing device with optional touchscreen and optional pen input. Optionally the example in 6c may be connected to a tablet or other device 6a. It may also optionally be connected to or contain output devices including without limitation, speakers, other displays, a network, or other output devices.

FIG. 7 shows an exemplary illustration of a user interface for generating signals from images of some embodiments of devices as shown in FIG. 6. The display 70 is optionally a touch-sensitive screen. In some embodiments the display 70 can receive inputs from a mouse, a pen stylus 71 that is optionally pressure-sensitive, or in haptic form by the user 72. Other inputs are also possible, such as a microphone (not shown). In some embodiments the display 70 is a pressure sensitive screen. In other embodiments one or more user interfaces outlined above are possible simultaneously or individually at different times. On the display 70, in some embodiments the user can draw images 73, 74, with pen stylus 71 or with by hand 72 or both. In some embodiments images are available from an image palette 75 or available to load from a menu 76.

Expanding on the user interface in FIG. 7, FIG. 8 further illustrates user interface features of some embodiments. Some embodiments provide a user interface with a display 80. In some embodiments an optional pressure-sensitive pen stylus 81a is used to draw images 82a consisting of one or more pixels and one or more colors. In some embodiments with optional pen stylus 81b, an image 81a or image region can be expanded by selecting the image or image region at one location 81c and moving the pen stylus to a second location 81d to create a new image 82b. Some embodiments provide a haptic user interface where an image 84a can be selected at any pixel location, in this example location 83a, and modified, for example, by stretching the image 84a from a first location 83a to a second location 83b. The result is a new image 84b. Some embodiments provide a user input menu 85 which may include image icons 86 for storing, saving, loading, or displaying new or previously created images. These images may be selected, stored, saved, or loaded by the user to draw in the drawing display area 80. Furthermore, some embodiments provide user interface icons 87 to for playback, reverse, saving, and new file creation. Some embodiments provide icons for a plurality of brush tip effects 88. The brush tip effects 88 can be used for the purpose of drawing images in conjunction with one or more of the pen styluses 81a, 81b, the haptic interfaces 83a, 83b, or other user interfaces and input devices. Furthermore, the brush tip effects 88 can be used in conjunction with image icons 86 such that a selected brush tip effect 88 will draw using a selected image icon 86. the For an exemplary illustration of haptic modification from an original position It should be noted that the example outlined above is one illustration and that a plurality of drawing methods exist including without limitation dragging, pasting, rotating, adding, multiplying, blurring, filtering, subtracting, rotating, and any other drawing method used to draw images on a display with pixels. Drawing methods including but not limited to the methods listed above may be used iteratively or simultaneously on a single image or multiple images.

FIG. 9 is an illustration of an exemplary user interface that provides the creation of a second image from an original image or image region using, for example, a blur effect in some embodiments, but other effects are possible.

FIG. 10 is an illustration of a user interface of some embodiments that provides the creation of a custom brush from a selected image region. Some embodiments provide a display region 100 that is in some embodiments provide an interactive user interface. In some embodiments display region 100 provides for an image or images 101 to be displayed. In some embodiments a pen stylus 102 or other input selection device provides the selection of an image region 103 of any shape or size consisting of one or more pixels of the image 101. The selected image region 103 can be cut, copied, stored, or saved in a user interface menu 110 in some embodiments. The user interface menu 110 provides an icon of the selected image region 103 and is sometimes displayed as 106 in some embodiments. Additionally, in some embodiments the user interface provides the ability to draw a new image 105 based on previously selected image region 103 or stored selection region 106. A second image 105 can be created from a previously selected image region 103 or stored region 106 by beginning at a first location 104a on display user input area, dragging the selected image region 103 to a second display location 104b as provided by some embodiments.

The invention claimed is:

1. A system and method of generating signals from images in response to user inputs providing a program on an electronic system comprising
Non-volatile and volatile memory storing a program that runs on processor(s)
Instructions for providing a user interface and a method of transforming images into signals.
Optional display with optional interactive capability providing a user interface with capability receiving inputs from the user interface to generate an output signal from images;

2. The method of claim 1, the method further comprising:
A user interface comprising a drawing region on optional display whereby an image of any shape size, or origin is transformed into a signal by means of a transform being part of the program set of instructions, the transform providing:
A method for converting image data in the form of discrete pixels on a display with position and color intensity information into a signal with discrete level and ordering;
A method to convert images into signals whereby a unique, one-to-one relationship between an image pixel location and its color or intensity value and its corresponding position and level in the output signal is provided;

3. The system of claim 1 for generating signals from images comprising a stored program in memory, a processing unit(s), storage media, volatile and non-volatile memory, a data bus, provisions for devices inputs and device outputs, file I/O and networking;

4. An electronic system of claim 3 wherein a user interface area is provided on a plurality of device configurations, comprising:
display(s) with or without interactive capability, provisions for device inputs including a mouse, keyboard, haptic touch-screen, pen-stylus, pressure-sensitive pen tablet device, microphones, and other input devices;

5. The electronic system of claim 4 further providing a system and method of output further comprising optional:
Speakers for audio output of signals generated from images, storage medium for saving signals generated from images to files;

6. The method of claim 2, further comprising a user interface providing interactive selection of an image or image region or regions on a display to be transformed to output signals;

7. The method of claim 6, wherein the user interface allows image or image regions to be selected, then modified for example by dragging one or more corners at a first location on the screen to a second location on the screen to create a second image to generate a second signal different from the first signal generated from the first image;

8. Furthering the method of claim 7, whereby an image or image region can be selected in a drawing area or from an interactive menu and the image or image region can be used to draw a second image by dragging, stretching, pasting, rotating, filtering, blurring, cropping, expanding or other means whereby a first image can be modified into a second image and transformed to generate a signal;

9. The method of claim 8, generating signals from images:
the method furthered by storing an image or image regions to a file or loading an image or image regions from a file; the method furthered by providing a palette of pencil, pen and brush tip effects for the purpose of drawing images to transform and generate signals;

10. The method of claim 9 further comprising of a custom brush selection storage tool whereby the user selects an image or image region and stores it as a custom brush for the purpose of drawing images from said stored custom brush to generate signals from images.

11. A system and method of generating signals from images of furthering the system and method of claim 4, further comprising a display with optional user inputs providing
Optional pressure sensitive pen input device interface for drawing pixelated images on said display where pressure applied to pen input device is proportional to the image color or intensity values transformed into signals

12. The system and method of claim 1 further comprising a program set of instructions residing on computer memory providing a user interface for generating signals from images in response to user inputs residing on non-volatile and volatile memory storing a program that runs on processor(s) further comprising instructions providing a user interface and a method of transforming images into signals. A display with optional interactive capability providing a user interface with capability:
Receiving inputs from the user interface to generate an output signal from images in real time for example a live musical performance;

13. The system and method of claim 2. The method further comprising:
A user defined transform converting pixel color intensity level and position into a signal, the transform providing the relationship between the discrete color or intensity level and pixel location in the image to the position and level of the output signal. A user interface whereby an image of any shape size, or origin is transformed into a signal by means of a transform being part of the program set of instructions, the transform providing:
A method for converting image data in the form of discrete pixels on a display with position and color intensity information into a signal with discrete level and ordering;
A method to convert images into signals whereby a unique, one-to-one relationship between an image pixel location and its color or intensity value and its corresponding position and level in the output signal is provided;

14. The system and method of claim 5. The electronic system further providing a system and method of output comprising:
Digital to analogue conversion of signals generated from images for signal output. Digitization of signals generated from images for storage as numerical data further used as output to devices or files on storage media for saving signals generated from images to files.

15. A system and method of generating signals from images, furthering claim 6, comprising a user interface providing interactive selection of an image or image region or regions on a display to be transformed to output signals whereby the user interface is (voice activated);
Furthering the method of claim 7, wherein the user interface allows image or image regions to be selected, then modified for example by dragging one or more corners at a first location on the screen to a second location on the screen to create a second image to generate a second signal different from the signal generated from the first image; whereby the images selected in the user interface via voice commands.

16. The system and method of claim 8, whereby an image or image region can be selected in a drawing area or from an interactive menu and the image or image region can be used to draw a second image or images by dragging, stretching, pasting, rotating, filtering, blurring, cropping, expanding or other means whereby an image can be modified and transformed to generate a signal further comprising input in the form of voice commands.

17. The system and method of claim 13. further comprising of a custom transform selection stool whereby the user selects an optional pre-defined transform for generating signals from images and stores it as a custom transform for the purpose generating signals from images. The method further providing the capability for editing of said user defined transforms of any origin for generating signals from images.
While the foregoing written description of the invention enables one of ordinary skill to make and use what is considered presently to be the best mode thereof, those of ordinary skill will understand and appreciate the existence of a plurality of variations, combinations, and equivalents of the specific embodiments, systems, method, and examples herein. The invention should therefore not be limited by the above described, but by all embodiments and methods within the scope and spirit of the invention as claimed.
